(19) United States
(12) Patent Application Publication
(10) Pub. No.: US 2011/0217688 A1
(43) Pub. Date: Sep. 8, 2011

(54) Method and System for Presenting Digital Instruction

(76) Inventor: Lydia Wellman Neher, Dallas, TX (US)

(21) Appl. No.: 12/982,726

(22) Filed: Dec. 30, 2010

Related U.S. Application Data
(60) Provisional application No. 61/311,566, filed on Mar. 8, 2010.

(51) Int. Cl. G09B 25/00

(52) U.S. Cl. 434/365

(57) ABSTRACT

A method is provided that includes receiving, on a computer system, a display stream from a handheld calculator operatively connected to the computer system, wherein the display stream comprises screen images displayed on the handheld calculator, presenting the screen images in the display stream on a display device coupled to the computer system as the display stream is received, storing the display stream as the display stream is received, pausing the presenting of the display stream responsive to user input, wherein the receiving and the storing are not paused, and resuming presentation of the screen images responsive to user input, wherein at least a portion of the screen images in the stored display stream is presented on the display device responsive to user selection of presentation controls.

### CROSS-REFERENCE TO RELATED APPLICATIONS

This application claims benefit of U.S. Provisional Patent Application Ser. No. 61/311,566, filed Mar. 8, 2010, which is incorporated herein by reference in its entirety.

### BACKGROUND OF THE INVENTION

A teacher can currently use an interactive instruction system, e.g., a handheld calculator connected to a computer system and a display device such as a digital projector and screen or interactive whiteboard, in a classroom to replicate the display of the handheld calculator in real time in a larger format on the display device for viewing by students, i.e., for presenting digital instruction to the students. More specifically, the teacher can perform operations using the handheld calculator and allow the students to view the results of the operations in real-time in the larger format provided by the display device. A teacher may also record a video from a sequence of operations performed on the handheld calculator, e.g., a lesson, in a file and play the recorded video to present it on the display device. However, further improvements in the presentation of digital instruction using a handheld calculator are desirable to enhance the student learning experience.

### BRIEF DESCRIPTION OF THE DRAWINGS

Particular embodiments in accordance with the invention will now be described, by way of example, and with reference to the accompanying drawings:

FIGS. 1A and 1B show interactive instruction systems in accordance with one or more embodiments of the invention;

FIG. 2 shows an example of a calculator in accordance with one or more embodiments of the invention;

FIG. 3A is a block diagram of a calculator in accordance with one or more embodiments of the invention;

FIG. 3B is a block diagram of a computer system in accordance with one or more embodiments of the invention;

FIGS. 4A-4E show an example user interface in accordance with one or more embodiments of the invention;

FIG. 5 is a flow diagram of a method in accordance with one or more embodiments of the invention; and

FIGS. 6 and 7 are examples in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components of computer and handheld calculator systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless connection. Thus, if a first device couples to a second device, that connection may be through a direct connection, through an indirect connection via other devices and connections, through an optical connection, and/or through a wireless connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps and/or number of steps shown in the figures and/or described herein.

Embodiments of the present invention are discussed below with respect to an embodiment in which a handheld calculator is used as an input device. It should be noted, however, that embodiments of the present invention may be useful for other types of electronic devices, e.g., laptop computers, desktop computers, handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

Embodiments of the invention provide for the improved presentation of operations performed on a handheld calculator, e.g., digital instruction in an interactive instruction system. More specifically, embodiments of the invention provide functionality for presenting handheld calculator operations not found in prior art interactive instruction systems. This functionality may include the ability to pause real time presentation on a display device connected to a computer system of sequential screen images received from a handheld calculator and to record the received screen images as the handheld calculator is used while the presentation is paused. A screen image is a representation of the complete content of the display on the handheld calculator, and a new screen image may be captured for transmission each time a change is made to the content of the display.

When presentation of the screen images is resumed, the presentation may be resumed with the current screen image on the handheld calculator display screen or resumed from the point where it was paused, presenting the recorded screen images. Even if the user resumes the presentation with the current screen image, the user may back up to any point in the recorded screen images, i.e., rewind, and begin presentation of the recorded screen images at that point. As the recorded screen images are presented, the user may fast forward, rewind, and/or pause the recorded screen images as they are being displayed. Further, in some embodiments of the invention, the real time screen images received from the handheld calculator are continuously recorded as they are being received/presented such that at any point in time the user may re-present some or all of the recorded screen images using fast forward, rewind, and/or pause operations. Also, at any time during presentation of the recorded screen images, the user may resume live presentation of screen images using a live operation that jumps to present the current screen image on the handheld calculator display.

In one or more embodiments of the invention, the key presses and/or touchpad actions on the handheld calculator may also be captured and shown on the display device in conjunction with the corresponding screen images. For example, as a user presses keys on the handheld calculator, each key press may be highlighted on a keypad “skin” displayed on the display device in proximity to the screen image display. In some embodiments of the invention, when the screen images are being recorded, the key presses and/or touchpad actions are also recorded and may be replayed when the recorded screen images are displayed, i.e., replayed synchronously with the corresponding recorded screen images. Further, in some embodiments of the invention, a key press and/or a touchpad action history may be shown on the display device in conjunction with corresponding screen images.

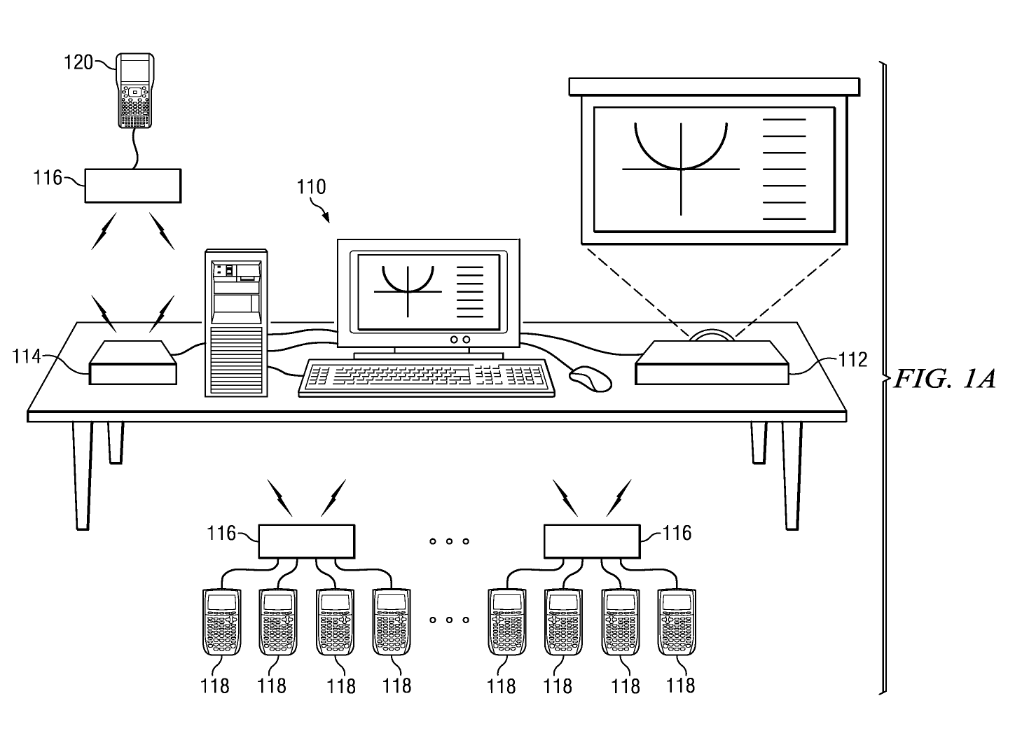

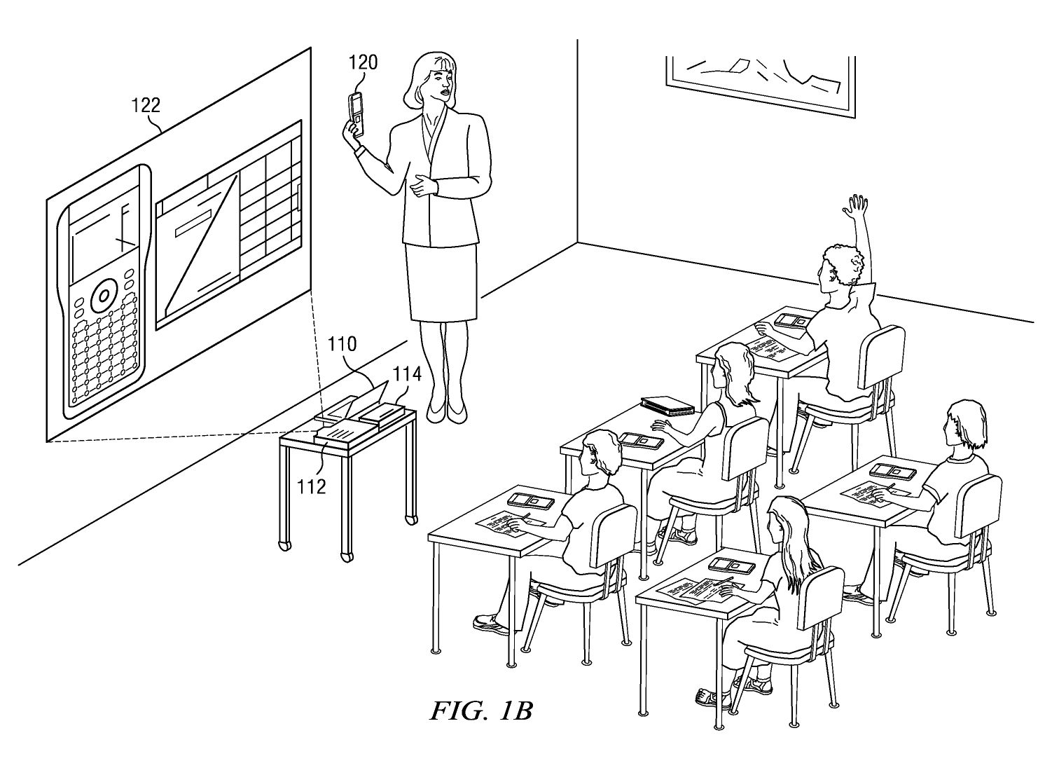

FIGS. 1A and 1B show diagrams of interactive instruction systems in accordance with one or more embodiments of the invention. The interactive instruction system of FIG. 1A includes a computer system (110) communicatively coupled to a projector (112) (e.g., a digital projector), which may project images and video provided by the computer system (110) onto a wall, screen, or other surface. The computer system (110) includes presentation software (not shown) for managing the presentation of screen content received from a handheld calculator (118, 120) as the handheld calculator is operated. The presentation may be made using a display device in the computer system (110), or using a combination of the display device and the projector (112). The functionality of one or more embodiments of the presentation software is described in more detail below. The computer system (110) may be any general purpose computing device, such as a desktop computer, a mini-computer, a main frame, a laptop computer, a netbook, or the like.

The computer system (110) is also communicatively coupled to an access point (114). The access point (114) provides an interface for the computer system (110) to communicate with one or more hubs (116). In one or more embodiments of the invention, the access point (114) provides a wireless interface, such as 802.11b, 802.11g, or the like, to the hubs (116). In some embodiments of the invention, the communications link between the access point (114) and the hubs (116) may be a wired communications link or a combination of wired and wireless. In some embodiments of the invention, one or more of the wired interface are USB communications links. Once connected, bi-directional communications may be performed between the handheld calculators (118, 120) and the computer system (110) via the hubs (116) and the access point (114).

The computer system (110), the access point (114), the hubs (116), and the handheld calculators (118) are illustrated as separate components for illustrative purposes only. Two or more of these components may be integrated into a single component. For example, the access point (114) may be integrated into the computer system (110), and a wireless transceiver may be integrated into the handheld calculators (118, 120) or externally attached via a port on a handheld calculator (118, 120) to allow wireless communication with the access point (114) and/or the computer system (110), thereby eliminating the hubs (116).

Each of the hubs (116) is communicatively coupled to one or more handheld calculators (118, 120). The handheld calculators may be any suitable handheld calculators, such as, for example, graphing calculators in the TI-Nspire product line available from Texas Instruments, Inc. As shown in FIG. 1, an instructor handheld calculator (120) is connected to one of the hubs (116) and student calculators (118) are connected to other hubs (116). The instructor handheld calculator (120) includes functionality to provide screen images displayed on the calculator display to the computer system (110) in real time, i.e., as the screen images are displayed on the calculator display. The screen images are transmitted as a display stream to the computer system (110) via the hub (116) connected to the instructor handheld calculator (120) and the access point (114). The screen images in the display stream may be encoded using any suitable encoding technique and the display stream may be transmitted using any suitable transmission protocol.

In some embodiments of the invention, the instructor handheld calculator (120) also includes functionality to provide the key presses and/or touchpad actions corresponding to the screen content, i.e., the sequence of key presses and or touchpad actions performed on the calculator to cause the screen images to be displayed on the calculator display, to the computer system (110). That is, as a user presses keys and/or used a touchpad on the instructor handheld calculator (120), key press and/or touchpad action indicators and the corresponding screen images on the calculator display are provided to the computer system (110). Key press indicators representing the key presses and/or touchpad action indicators representing the touchpad actions may be included in the display stream using a protocol that associates the key presses and/or touchpad actions with the corresponding screen content.

In some embodiments of the invention, one or more of the other handheld calculators (118) include functionality similar to that described above for the instructor handheld calculator (120). That is, one or more of the other handheld calculators (118) also includes the functionality to provide screen images in display streams to the presentation software, and in some such embodiments, also includes the functionality to provide corresponding key presses and/or touchpad actions to the computer system (110). In such embodiments, the presentation software includes functionality to allow any of the instructor handheld calculator (120) and other of the similarly configured handheld calculators (118) to be used as the input to the computer system (110) for presentation on the display device. For example, the user of the presentation software on the computer system (110) may select the instructor handheld calculator (120) or any one of the appropriately configured handheld calculators (118) to provide the presentation input to the presentation software.

In one or more embodiments of the invention, the instructor handheld calculator (120) and/or the handheld calculators (118) are directly connected to the computer system (110) with wired connections, e.g., using one or more USB ports in the computer system (110) and/or USB hubs connected to the one or more USB ports. In such embodiments, an access point (114) is not needed for the directly connected handheld calculators. In some embodiments of the invention, one or more of the handheld calculators (118, 120) may communicate wirelessly with the access point (114) instead of via the hubs (116). That is, a wireless adaptor or a wireless cradle may be attached to the one or more handheld calculators (118, 120) via ports on the handheld calculators, thus allowing the calculators to communicate wirelessly with the access point (114).

In one or more embodiments of the invention, computing devices other than the handheld calculators (118, 120) may be included in an interactive instruction system in lieu of one or more of the handheld calculators (118, 120). For example, laptop computers, desktop computers, and/or netbooks may replace one or more of the handheld calculators (118, 120). In such embodiments, the access point (114) may not be needed for the computing devices. For example, the connections between the computer system (110) and the computing devices may be via a wireless network using IP addresses.

FIG. 1B shows an example of an interactive instruction system in a classroom setting. In this embodiment, the computer system (110) is a laptop computer, and the access point (114) is connected by a USB connection to the computer system (110). The instructor's handheld calculator (120) and the handheld calculators in use by the students are all connected by a wireless communication link to the access point (114). The presentation software executing on the computer system (110) is showing the content, i.e., screen image, of the display on the instructor's handheld calculator (120) on the display device of the computer system (110) and on the screen (122) via the projector (112) along with a “skin” duplicating the appearance of the instructor's handheld calculator (120). As is explained in more detail herein, as the instructor conducts a lesson using the handheld calculator (120), the presentation software (in this embodiment) executing on the computer system (110) receives both the screen images shown on the display of the handheld calculator (120) and the corresponding key press sequences and touchpad actions of the instructor in real time and displays the screen images on the display device of the computer system (110). The projector (112) is used to project the information shown on the display device onto the screen (122). The presentation software also highlights keys on the skin to show the key press sequences and touchpad actions. The presentation software may present the screen images/key presses/touchpad actions in real time, i.e., live, or may record the screen images/key presses/touchpad actions and replay the display stream and key presses/touchpad actions using presentation controls such as fast forward, pause, resume, refresh, and “jump” to live.

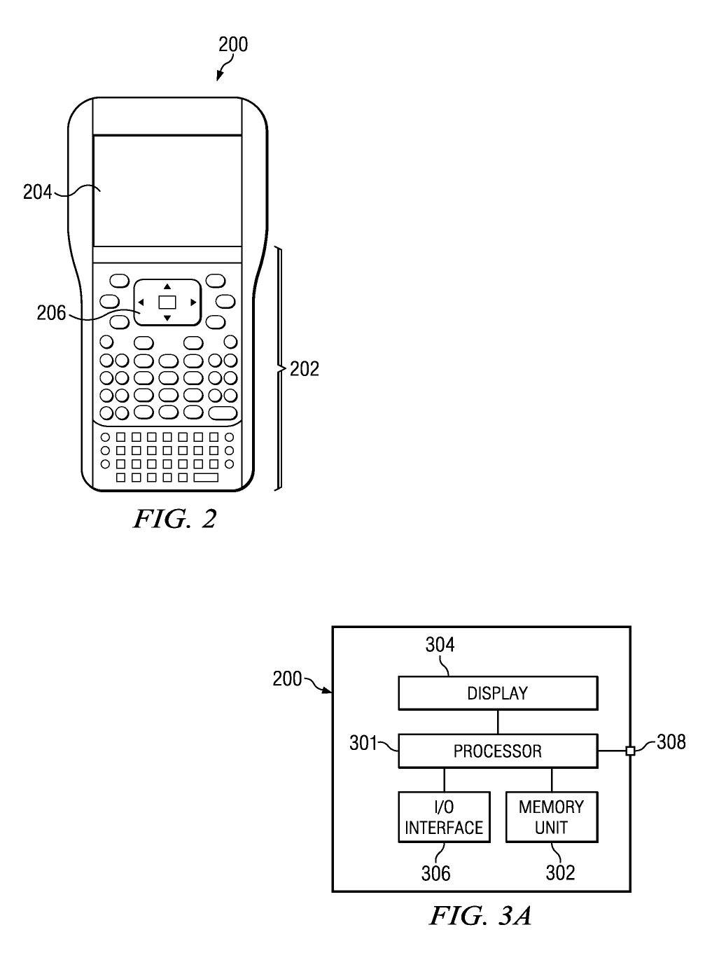

FIG. 2 shows an example of a handheld calculator (200) (e.g., 118, 120 of FIGS. 1A and 1B) in accordance with one or more embodiments of the invention. For illustrative purposes, the handheld calculator illustrated in FIG. 2 is similar to graphing calculators available from Texas Instruments Inc. Handheld calculators with more or fewer components may be used in embodiments of the invention. As shown in FIG. 2, the handheld calculator (200) includes a graphical display (204), and a keypad (202) that includes a touchpad (206). The graphical display (204) may be used to display, among other things, information input to applications executing on the handheld calculator (200) and various outputs of the applications. The graphical display (204) may be, for example, an LCD display. The keypad (202) allows a user, e.g., a student or instructor, to enter data and functions and to start and interact with applications executing on the handheld calculator (200). The keypad (202) also includes an alphabetic keyboard for entering text. The touchpad (206) allows a user to interact with the display (204) by translating the motion and position of the user's fingers on the touchpad (206) to provide functionality similar to using an external pointing device, e.g., a mouse. A user may use the touchpad (206) to perform operations similar to using a pointing device on a computer system, e.g., scrolling the display (204) content, pointer positioning, selecting, highlighting, etc.

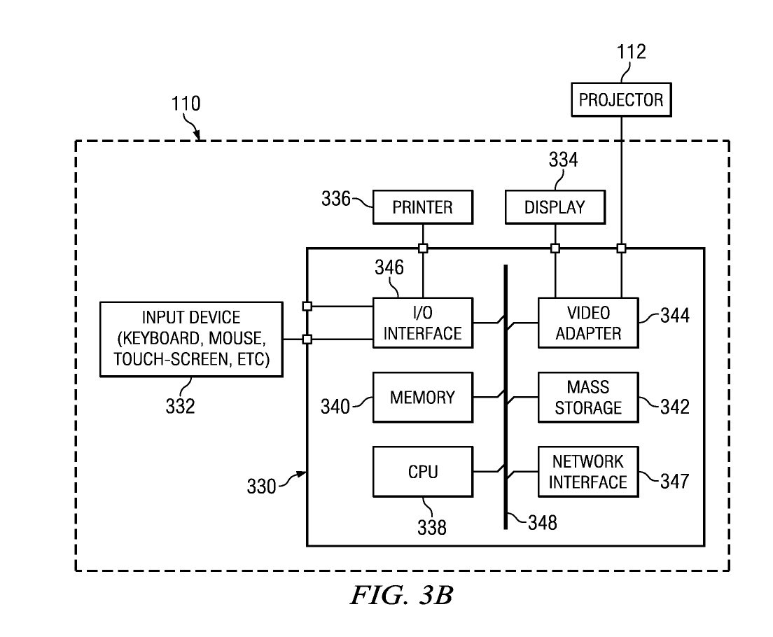

FIGS. 3A and 3B are block diagrams of the handheld calculator (200) and the computer system (110), respectively, in accordance with one or more embodiments of the invention. The handheld calculator (200) includes a processor (301) coupled to a memory unit (302), which may include one or both of read-only memory (ROM) and random-access memory (RAM). In some embodiments of the invention, the ROM stores software programs and the RAM stores intermediate data and operating results. An input/output port (308) provides connectivity to external devices, e.g., a hub (116) of FIG. 1 or the computer system (110). In one or more embodiments of the invention, the input/output port (308) is a bi-directional connection such as a mini-A USB port. Also included in the handheld calculator (200) are a display (304) and an I/O interface (306). The I/O interface (306) provides an interface to couple input devices such as the touchpad (206) and the keypad (202) to the processor (301). In some embodiments of the invention, the handheld calculator (200) may also include an integrated wireless interface (not shown) or a port for connecting an external wireless interface (not shown).

The computer system (110) includes a processing unit (330) equipped with one or more input devices (332) (e.g., a mouse, a keyboard, or the like), and one or more output devices, such as a display (334), a printer (336), or the like. In some embodiments of the invention, the display (334) may be touch screen, thus allowing the display (334) to also function as an input device. The processing unit (330) may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, an interactive white board, or a combination thereof.

The processing unit (330) includes a central processing unit (CPU) (338), memory (340), a mass storage device (342), a video adapter (344), and an I/O interface (346) connected to a bus (348). The bus (348) may be one or more of any type of several bus architectures including a memory bus or memory controller, a peripheral bus, video bus, or the like. The CPU (338) may be any type of electronic data processor. For example, the CPU (338) may be a processor from Intel Corp., a processor from Advanced Micro Devices, Inc., a Reduced Instruction Set Computer (RISC), an Application-Specific Integrated Circuit (ASIC), or the like. The memory (340) may be any type of system memory such as static random access memory (SRAM), dynamic random access memory (DRAM), synchronous DRAM (SDRAM), read-only memory (ROM), a combination thereof, or the like. Further, the memory (340) may include ROM for use at boot-up, and DRAM for data storage for use while executing programs.

The mass storage device (342) (e.g., a computer readable medium) may comprise any type of storage device configured to store data, programs, and other information and to make the data, programs, and other information accessible via the bus (348). In one or more embodiments of the invention, the mass storage device (342) stores the presentation software to be executed by the CPU (338). The mass storage device (342) may be, for example, one or more of a hard disk drive, a magnetic disk drive, an optical disk drive, or the like. The presentation software may be initially stored in a computer-readable medium such as a compact disc (CD), a diskette, a tape, a file, memory, or any other computer readable storage device and loaded and executed by the CPU (338). In some cases, the presentation software may also be sold in a computer program product, which includes the computer-readable medium and packaging materials for the computer-readable medium. In some cases, the presentation software may be distributed to the computer system (110) via removable computer readable media (e.g., floppy disk, optical disk, flash memory, USB key), via a transmission path from computer readable media on another computer system (e.g., a server), etc.

The video adapter (344) and the I/O interface (346) provide interfaces to couple external input and output devices to the processing unit (330). As illustrated in FIG. 3B, examples of input and output devices include the display (334) and projector (112) coupled to the video adapter (344) and the mouse/keyboard (332) and the printer (336) coupled to the I/O interface (346).

The processing unit (330) also includes a network interface (347). The network interface (347) allows the processing unit (330) to communicate with remote units via a network (not shown). In one or more embodiments of the invention, the network interface (347) allows the computer system (110) to communicate via a network to the handheld calculators (118, 120). The network interface (347) may provide an interface for a wired link, such as an Ethernet cable or the like, or a wireless link.

The computer system (110) may also include other components not specifically shown. For example, the computer system (110) may include power supplies, cables, a motherboard, removable storage media, cases, and the like.

The presentation software on the computer system (110) includes functionality to receive the display stream from the handheld calculator (120) and display the screen images provided on the display device of the computer system (110) along with a user interface for controlling the presentation of the screen images. In one or more embodiments of the invention, the presentation software includes functionality to allow a user to select one of the handheld calculators (118, 120) to provide the display stream for presentation. Further, in some embodiments of the invention, two or more of the handheld calculators (118, 120) may be selected to provide display streams for simultaneous presentation. As is explained in more detail herein, the interface for controlling the presentation may include allowing the user to pause/resume the display stream, move to another point within the display stream, rewind the display stream, fast forward the display stream, and/or resume display of the real time display stream, e.g., to jump to live display of screen images from the handheld calculator (120). The presentation software also includes functionality to store, i.e., record, the display stream as it is received. The display stream may be stored in the format received and/or in any other suitable format, e.g., audio visual interleave (avi) format. In some embodiments of the invention, the entire display stream is stored for the duration of the presentation session. In some embodiments of the invention, the amount of the display stream stored is less than the entire display stream. For example, a buffer may be used to store a portion of the display stream as it is received such that when the buffer becomes full, the oldest portion of the stored display stream is eliminated to make room for newer portions. The size of this buffer may be fixed or may be set by user input.

In some embodiments of the invention, the presentation software also includes functionality to display key presses and/or touchpad actions corresponding to the screen images according to key press indicators and/or touchpad indicators received in the display stream. The display of the key presses and/or touchpad actions may be a key press/touchpad action history and/or by highlighting keys and/or a touchpad on a calculator skin displayed in conjunction with the screen images.

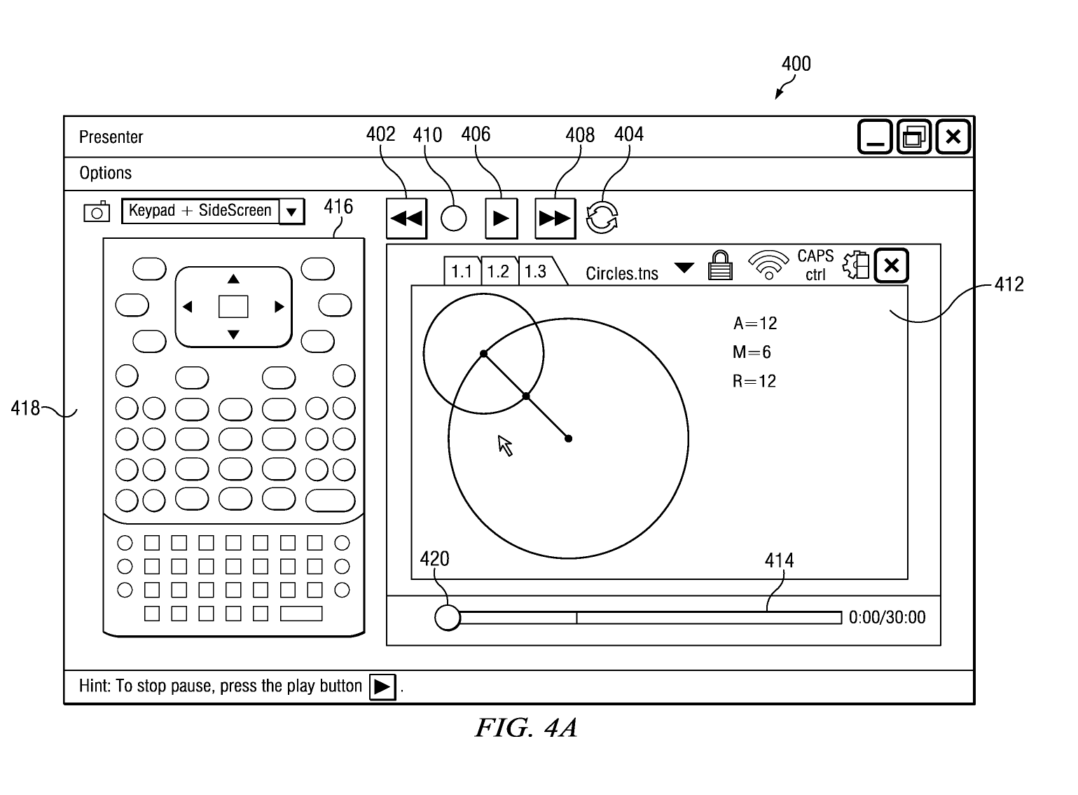

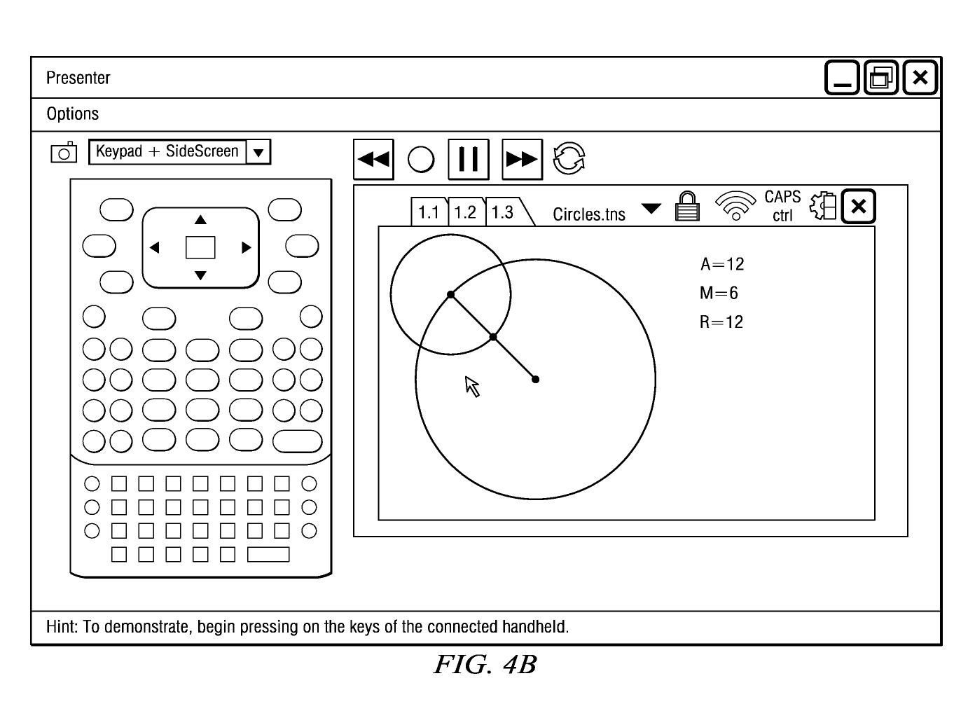

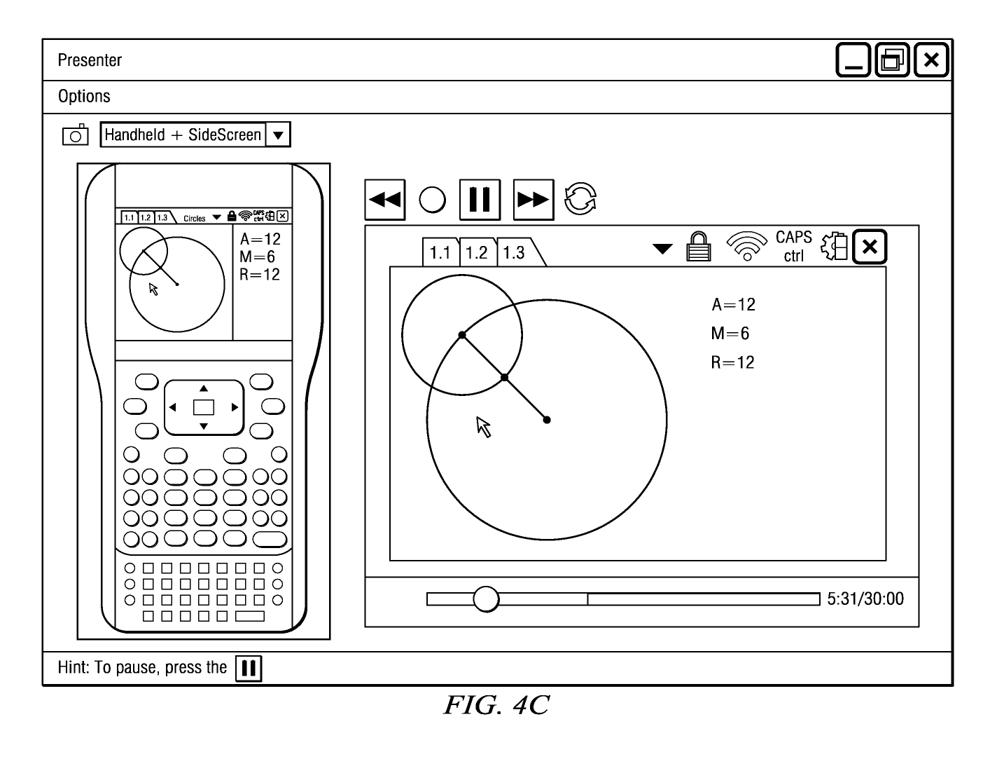

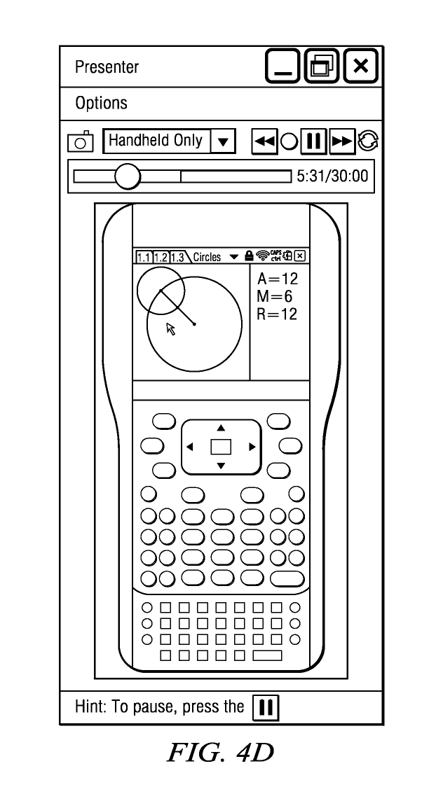

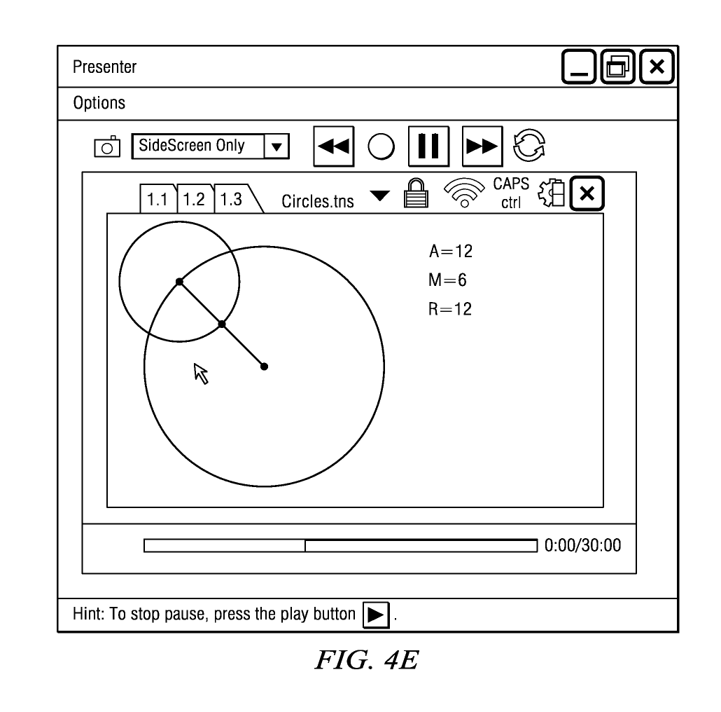

The functionality included in one or more embodiments of the presentation software for controlling the presentation of the display stream is now explained way of the examples of FIGS. 4A-4E. The appearance and content of these examples is merely for illustration purposes and should not be construed as limiting the claimed invention. One of ordinary skill in the art will understand that there are many ways in which the control functionality may be made available to a user.

FIG. 4A shows an example of a user interface (400) provided by the presentation software in accordance with one or more embodiments of the invention. The user interface includes presentation controls, e.g., control buttons (402-408), to allow the user to control the presentation of the display stream, e.g., pause/resume (406), fast forward (408), and reverse (402), a screen display pane (412) for presenting the screen images, and a calculator display pane (416) for showing a calculator view. The calculator view shows an image of a calculator. In some embodiments of the invention, the image duplicates the appearance of the handheld calculator used for the presentation. For example, if the handheld calculator providing the display stream for presentation is a TI-Nspire CAS handheld calculator, the presentation software detects that this type of calculator is being used, and duplicates the appearance of the TI-Nspire CAS in the calculator display pane (416).

The calculator image may show the keypad only, or the entire calculator. When the entire calculator is shown, the display portion of the calculator image displays the screen images from the display stream. Further, as the screen images in the display stream are presented, keys and/or the touchpad on the keypad in the calculator view (416) are highlighted based on key press indicators and/or touchpad action indicators provided in the display stream. In some embodiments of the invention, a key press and/or touchpad action history may also be shown.

A live control button (404) is provided to allow the user to “jump” the presentation to immediately resume real time, i.e., live, display of the display stream from the calculator. A record button (410) is also provided to allow the user to record the presentation as a movie, e.g., an avi file. A display control bar (414) is also provided that shows how much of the display stream is available and a relative position of the screen image in the screen display pane (412) in the available display stream. The user may use a pointing device (e.g., a mouse, the user's finger) on the display location control (420) on the display control bar (414) to move forward and backward in the available display stream to choose a presentation point within the available display stream, including moving to the end of the available display stream to resume displaying the real time display stream from the handheld calculator (120).

The pause/resume control button (406) allows the user to pause and resume playing the display stream. Using this control button, the user can pause the real time presentation of the display stream from the calculator and continue using the handheld calculator (120). During the continued use, the presentation software will continue to record the received display stream without displaying it. At any time, the user can use the pause/resume control button (406) to resume presentation of the display stream at the point the display stream was paused. The user can use the rewind control button (402) and the fast forward control button (408) to move backward and forward through the stored display stream. As the rewind or fast forward operations are performed, screen images from the display screen are shown in the screen display pane (412). The button and/or touchpad highlighting on the keypad may also be shown as the rewind and fast forward operations are performed. When a key press and/or touchpad action history is shown, the history is also changed as the rewind and fast forward operations are performed. The user can use the live button (404) at any point to immediately resume display of the real time display stream from the handheld calculator (120), i.e., to “jump” to live presentation of screen images, etc. received from the handheld calculator (120).

A configuration drop down menu (418) is provided to allow the user to change what is shown in the presentation. More specifically, the drop down menu (418) allows the user to change the display screen layout. FIGS. 4B-4E show four example display screen layouts. The display screen layout of FIG. 4B is the same as that of FIG. 4A, i.e., a combination of a calculator keypad in the calculator display pane (416) and the screen images in the screen display pane (412). In the display screen layout of FIG. 4C, the full calculator is shown in the calculator display pane (416) and the screen images are shown in the screen display pane (412). Note that with this option, the screen images in the display stream are shown both in the calculator display pane (416) and the screen display pane (412). In the display screen layout of FIG. 4D, the calculator display pane (416) with the full calculator is shown and the screen display pane (412) is not shown. In the display screen layout of FIG. 4E, the screen display pane (412) is shown and the calculator display pane (416) is not shown.

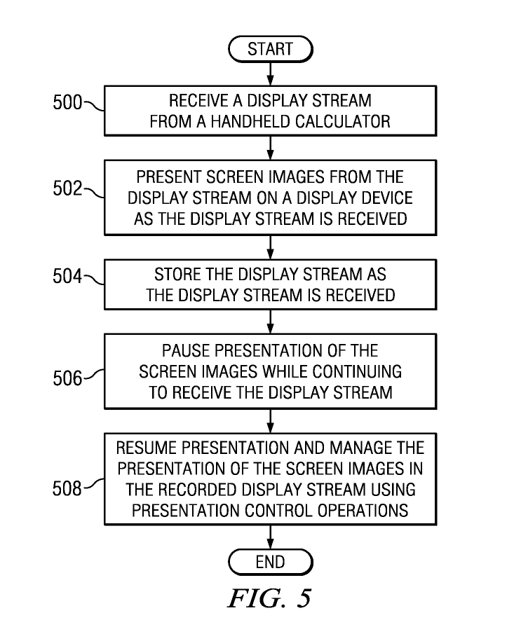

FIG. 5 is a flow diagram of a method for presentation of screen images from a handheld calculator in accordance with one or more embodiments of the invention. Initially, a display stream is received from the handheld calculator (500). The display stream is received as the handheld calculator is being operated. Screen images in the live display stream are presented on a display device as the display stream is received (502). If the display stream includes key press indicators and/or touchpad action indicators corresponding to the screen images, the key presses indicated by the key press indicators and/or the touch pad actions indicated by the touchpad action indicators may also presented. The display stream is also stored as the display stream is received (504). As previously mentioned, the entire received display stream may be stored or the display stream may be buffered in a fixed size buffer on a first in first out basis. The presentation of the screen images in the display stream is paused while continuing to receive the display stream from the handheld calculator (506). That is, the screen images are no longer shown on the display device but the display stream continues to be received from the handheld calculator as the handheld calculator is operated. Presentation of the screen images is then resumed and the presentation of the screen images in the recorded display stream is managed using presentation control operations (508). The presentation control operations may be as previously described, e.g., rewind, fast forward, pause/resume, and/or live presentation control operations.

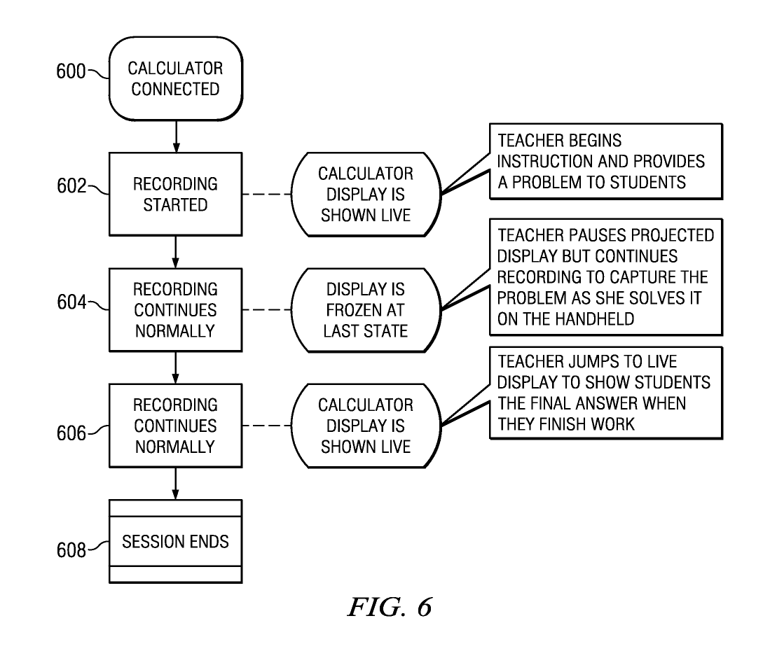

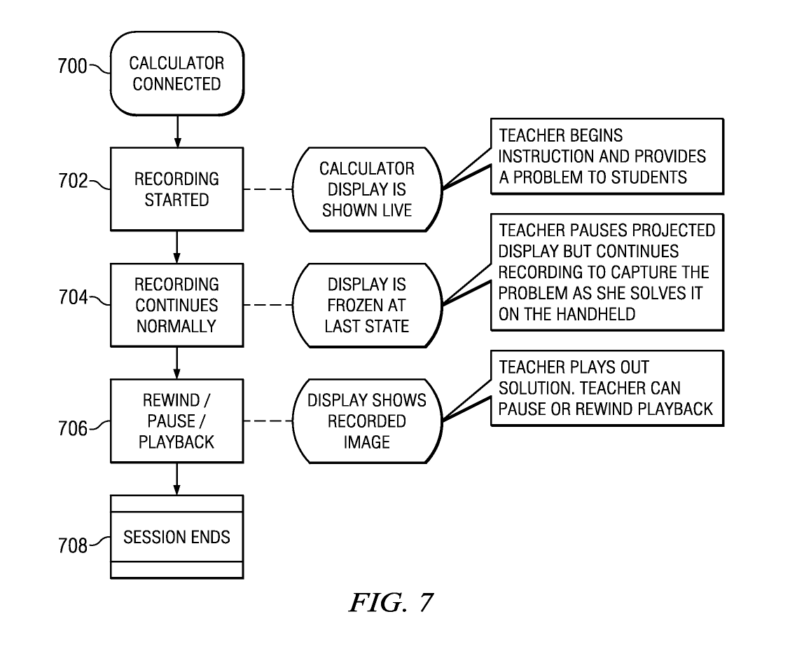

FIGS. 6 and 7 show examples of use of an embodiment of an interactive instruction system in as described herein by a teacher. As shown in FIG. 6, initially, the teacher's handheld calculator is connected to the interactive instruction system such that the operations, i.e., screen images and key presses/touchpad actions, performed on the handheld calculator are presented on a display device in the interactive instruction system (600). The teacher begins instruction and provides a problem to the students. Recording of the screen images and the key presses/touchpad actions is started as the teacher uses the handheld calculator (602). The teacher pauses the presentation of handheld calculator operations and continues to use the handheld calculator to solve the problem. The presentation on the display device is frozen at its last state, i.e., the state when the presentation was paused, but recording of the operations on the handheld calculator continues as the teacher uses it (604). The teacher waits until the students finish solving the problem and then resumes presentation of the handheld calculator operation, jumping to live display on the handheld calculator to show the students the final answer. Recording of the handheld calculator operation continues (606) until the session is ended (608).

As shown in FIG. 7, initially, the teacher's handheld calculator is connected to the interactive instruction system such that the operations, i.e., screen images and key presses/touchpad actions, performed on the handheld calculator are presented on a display device in the interactive instruction system (700). The teacher begins instruction and provides a problem to the students. Recording of the screen images and the key presses/touchpad actions is started as the teacher uses the handheld calculator (702). The teacher pauses the presentation of handheld calculator operations and continues to use the handheld calculator to solve the problem. The presentation on the display device is frozen at its last state, i.e., the state when the presentation was paused, but recording of the operations on the handheld calculator continues as the teacher uses it (704). The teacher waits until the students finish solving the problem and then resumes presentation of the handheld calculator operation, playing back the recorded operations using presentation controls such as rewind, fast forward, pause/resume, live, etc. (708) to demonstrate the solution steps to the students. After playback, the session is ended (708).

Using embodiments of the invention as described herein can assist teachers in delivery of instruction using handheld calculators. For example, a teacher may make more efficient use of classroom time. As students work out problems individually or as groups, the teacher can work the problem at the same time, recording the solution. When the class is ready, the teacher can show the students the step-by-step solution, rewinding and fast forwarding as needed. Currently, teachers have to wait for students to finish before starting on the solution in front of the class. Also, the amount of interaction between students and the teacher may increase as rather than splitting time between button presses/touchpad actions and student questions, the teacher may focus more on class discussion. Also, the teacher has the option to connect a student's handheld calculator, record the student's solution of the problem on the handheld calculator, and have the student demonstrate to the class how the problem is solved.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method comprising:
receiving, on a computer system, a display stream from a handheld calculator operatively connected to the computer system, wherein the display stream comprises screen images displayed on the handheld calculator;
presenting the screen images in the display stream on a display device coupled to the computer system as the display stream is received;
storing the display stream as the display stream is received;
pausing the presenting of the display stream responsive to user input, wherein the receiving and the storing are not paused; and
resuming presentation of the screen images responsive to user input, wherein at least a portion of the screen images in the stored display stream is presented on the display device responsive to user selection of presentation controls.

2. The method of claim 1, wherein the presentation controls comprise at least one selected from a group consisting of rewind, fast forward, pause, resume, and live presentation.

3. The method of claim 1, further comprising jumping to live presentation of screen images in the display stream responsive to user selection of a presentation control during the presentation of the screen images in the stored display stream.

4. The method of claim 1, wherein resuming presentation further comprises resuming presentation with the screen image currently displayed on the handheld calculator.

5. The method of claim 1, further comprising replicating keypad activity corresponding to the screen images on the display device, wherein the display stream further comprises keypad activity indicators representative of keypad activity performed on the handheld calculator.

6. The method of claim 5, wherein resuming presentation further comprises at least one selected from a group consisting of:
fast forwarding the stored display stream responsive to user selection of a presentation control until an indication to stop is received, wherein replicating the keypad activity comprises replicating fast forwarding of the keypad activity in the stored display stream, and
rewinding the stored displayed stream responsive to user selection of a presentation control until an indication to stop is received, wherein replicating the keypad activity comprises replicating rewinding of the keypad activity in the stored display stream.

7. The method of claim 1, further comprising moving the presentation of the screen images to a point in the recorded display stream responsive to user selection of the point using a display control bar.

8. An interactive instruction system comprising:
a computer system;
a display device operatively connected to the computer system; and
a handheld calculator operatively connected to the computer system, wherein the computer system is configured to
receive a display stream from the handheld calculator, wherein the display stream comprises screen images displayed on the handheld calculator;
present the screen images in the display stream on the display device as the display stream is received;
store the display stream as the display stream is received;
pause the presenting of the display stream responsive to user input, wherein receipt and storage of the display stream are not paused; and
resume presentation of the screen images responsive to user input, wherein at least a portion of the screen images in the stored display stream is presented on the display device responsive to user selection of presentation controls.

9. The interactive instruction system of claim 8, wherein the presentation controls comprise at least one selected from a group consisting of rewind, fast forward, pause, resume, and live presentation.

10. The interactive instruction system of claim 8, wherein the computer system is further configured to jump to live presentation of screen images in the display stream responsive to user selection of a presentation control during the presentation of the screen images in the stored display stream.

11. The interactive instruction system of claim 8, wherein the computer system is further configured to resume presentation with the screen image currently displayed on the handheld calculator.

12. The interactive instruction system of claim 8, wherein the computer system is further configured to replicate keypad activity corresponding to the screen images on the display device, wherein the display stream further comprises keypad activity indicators representative of keypad activity performed on the handheld calculator.

13. The interactive instruction system of claim 12, wherein the computer system is further configured to resume presentation by at least one selected from a group consisting of:
fast forwarding the stored display stream responsive to user selection of a presentation control until an indication to stop is received, wherein replication of the keypad activity comprises replicating fast forwarding of the keypad activity in the stored display stream, and
rewinding the stored displayed stream responsive to user selection of a presentation control until an indication to stop is received, wherein replication of the keypad activity comprises replicating rewinding of the keypad activity in the stored display stream.

14. The interactive instruction system of claim 8, wherein the computer system is further configured to move the presentation of the screen images to a point in the recorded display stream responsive to user selection of the point using a display control bar.

15. A computer readable medium comprising executable instruction to cause a computer system to perform a method comprising:
receiving, on the computer system, a display stream from a handheld calculator operatively connected to the computer system, wherein the display stream comprises screen images displayed on the handheld calculator;
presenting the screen images in the display stream on a display device coupled to the computer system as the display stream is received;
storing the display stream as the display stream is received;
pausing the presenting of the display stream responsive to user input, wherein the receiving and the storing are not paused; and
resuming presentation of the screen images responsive to user input, wherein at least a portion of the screen images in the stored display stream is presented on the display device responsive to user selection of presentation controls.

16. The computer readable medium of claim 15, wherein the presentation controls comprise at least one selected from a group consisting of rewind, fast forward, pause, resume, and live presentation.

17. The computer readable medium of claim 15, wherein the method further comprises jumping to live presentation of screen images in the display stream responsive to user selection of a presentation control during the presentation of the screen images in the stored display stream.

18. The computer readable medium of claim 15, wherein resuming presentation further comprises resuming presentation with the screen image currently displayed on the handheld calculator.

19. The computer readable medium of claim 15,
wherein the method further comprises replicating keypad activity corresponding to the screen images on the display device, wherein the display stream further comprises keypad activity indicators representative of keypad activity performed on the handheld calculator, and
wherein resuming presentation further comprises at least one selected from a group consisting of:
fast forwarding the stored display stream responsive to user selection of a presentation control until an indication to stop is received, wherein replicating the keypad activity comprises replicating fast forwarding of the keypad activity in the stored display stream, and
rewinding the stored displayed stream responsive to user selection of a presentation control until an indication to stop is received, wherein replicating the keypad activity comprises replicating rewinding of the keypad activity in the stored display stream.

20. The computer readable medium of claim 15, wherein the method further comprises moving the presentation of the screen images to a point in the recorded display stream responsive to user selection of the point using a display control bar.
